(19) United States
(12) Patent Application Publication
(10) Pub. No.: US 2006/0179448 A1
(43) Pub. Date: Aug. 10, 2006

(54) Multilayer dual optical disk

(76) Inventors: Wayne M. Smith, La Canada, CA (US); Alan Bell, San Marino, CA (US); Lewis S. Ostrover, Los Angeles, CA (US)

Correspondence Address: GOTTLIEB RACKMAN & REISMAN PC, 270 MADISON AVENUE, 8TH FLOOR, NEW YORK, NY, 100160601, US

(21) Appl. No.: 11/317,442

(22) Filed: Dec. 22, 2005

Related U.S. Application Data
(60) Provisional application No. 60/639,153, filed on Dec. 23, 2004.

(51) Int. Cl. G11B 7/24; G11B 23/03

(52) U.S. Cl. 720/718

(57) ABSTRACT

A data disc consists of several layers, including at least one layer conforming to a first format, and a second layer conforming to a second format. The formats can include CD, DVD, HD and BD formats and the layers may be physical, logic or application layers.

### RELATED APPLICATIONS

This application is based on provisional application Ser. No. 60/639,153 filed Dec. 23, 2004 and incorporated herein by reference.

### FIELD OF INVENTION

This invention pertains to an optical disc having at least two data layers, each layer having a different format, either physical format, application format, or both. More specifically, the invention pertains to an optical disc that includes one data layer having a standard CD or DVD format and a second data layer having a high-capacity format, and/or having two high capacity formats on one disc.

### DESCRIPTION OF THE PRIOR ART

During the last twenty years the rapid advancement of technology resulted in the developments of several new types of media that can be used for the distribution of content. The most popular of these media has been the DVD disc. Recently, new formats have been proposed that will improve significantly the amount of data that can be stored on a DVD disc without changing its physical dimensions. Two of such high-capacity formats are HD-DVD and Blu-ray Disc (or BD). Discs of both formats can be read using a blue-indigo laser beam having a wavelength in the range of 405 nm. A player with this beam can detect data pits that are much smaller and are arranged in a spiral that has a smaller pitch than standard DVD discs. The following table lists typical characteristics of standard DVDs and these two high-capacity formats:

| | CD | DVD | HD-DVD | BD |
|---|---|---|---|---|
| Laser | 780 | 650 | 405 | 405 |
| Wavelength (nm) | | | | |
| Laser | 0.45 | 0.6 | 0.65 | 0.85 |
| Aperture | | | | |
| Pit length (m) | 0.60 | 0.4 | 0.15 | 0.15 |
| Track Pitch (m) | 1.6 | 0.74 | 0.40 | 0.32 |
| Depth of cover layer (mm) | 1.2 | 0.6 | 0.6 | 0.1 |
| Data Capacity | 0.65-0.7 | 4.7 | 15 | 25 |
| Prerecorded disc | | | | |
| (Gb per layer) | | | | |

Rewritable discs have similar or larger capacities.

Multiple layer discs having one of these formats have been proposed as well, for example DVD-9, HD-DVD-30, HD-DVD-45 and BD-50. The construction of multiple layer discs is well-known in the art, and is variously described in patent publications such as EP1589531 (“Semi-reflective film and reflective film for optical information recording medium, and sputtering target”), US20050042406 and EP1505584 (“Metal alloys for the reflective or the semi-reflective layer of an optical storage medium”), US20040095827 and EP1469460 (“Optical recording/reproducing method and optical recording medium”) and US20050207326 and PCT/IB03/02570 [03107338] (“Dual stack optical data storage medium and use of such medium”), the disclosures of which are incorporated by reference herein.

A general problem with multiple formats of discs is that disc manufacturers must make various types of discs of each type in order to satisfy consumer demand for the content on those discs. A consumer that owns a standard DVD disc player can only play DVDs with a standard format. A consumer with a Blu ray recorder can only play Blu-ray format recordable discs. And a consumer with an HD-DVD disc player can only play HD-DVD discs or standard format DVDs, but not Blu-ray format discs. From the standpoint of a manufacturer, it is disadvantageous to have to manufacture and distribute three different types of disc formats to satisfy consumer demand for one product—such as a motion picture. Moreover, multiple formats of DVD discs create retail and consumer confusion as to which format(s) to acquire or buy.

As noted, another problem with the Blu-ray format is that, due to the relatively shallow depth of the data layer in a high capacity Blu-ray Disc (0.1 mm), at this time Blu-ray players and/or drives cannot easily be made backwards compatible with a standard DVD with a relatively deep data layer (0.6 mm) in a conventional system using a single laser and pick-up. And a problem with both of the HD-DVD and BD formats is that they are not compatible with each other because when used with high capacity discs the data is at different depths on the optical disc and the respective formats require different laser apertures. Therefore, as discs with higher capacities are being phased in, content will have to be distributed on as many as three different kinds of discs: standard DVD discs, and two types of high-capacity discs. As noted, this is undesirable for several reasons.

### SUMMARY OF THE INVENTION

The present invention provides novel multilayer discs having the combined characteristics of some of the prior art discs. For example, in addition to the use of data formats such as BD and HD-DVD on high capacity discs, for which those formats are primarily designed, due to manufacturing cost considerations it may be desirable in the case of video programs of shorter duration (e.g., around two hours or less) to utilize the standard definition DVD (“SD”) physical format in conjunction with a high definition application data format such as the DVD-HD or Blu-ray formats. For example, a so-called “BD-9” disc utilizes the physical format of a SD, dual-layer DVD-9 disc, but the data is be formatted in the BD application format. Similarly, a so-called “HD-DVD-9” disc utilizes the physical format of a SD, dual layer DVD-9 disc, but the data is formatted in the HD-DVD application format. In the case of programs of around one hour or less, it may be desirable to include a combination of formats (HD-DVD, BD and SD) on an SD physical format DVD-9 disc, with each format using one of the two physical layers. For example, what is referred to as a “HD/BD-5” disc includes a program in the BD application format on one layer of an SD physical format DVD-9 disc, and the same program in the HD-DVD application format on the other DVD-9 physical layer. Similarly, what an “HD/SD-5” disc includes a program in the HD-DVD application format on one layer of a SD physical format DVD-9 disc, and includes the same program in the SD application format on the other DVD-9 physical layer. Finally, a “BD/80-5” disc includes a program in the BD application format on one layer of a SD physical format DVD-9 disc, and includes the same program in the standard definition (SD) application format on the other DVD-9 physical layer.

In addition, sometimes it would be desirable to include audio-only content playable on a CD player on a multiple format DVD disc, or CD ROM data on a CD ROM layer, DVD ROM data on a DVD ROM, and/or Blu-ray ROM data on a BD ROM layer

These problems can be resolved in one of several ways. First, by providing discs that have DVD and Blu-Ray data layers at different depths of the same side of a DVD, e.g. one layer having standard DVD physical and application format, with the other layer having Blu-ray high-capacity physical and application format. Second, by providing discs that have two different format data layers at the same relative depth (i.e. nominally around 0.6 mm for each, whether the format is DVD, BD or HD-DVD) of one side of a DVD, one layer being of a standard DVD format and the other being of the HD-DVD format. Third, by providing discs that have two different application format data layers at the same depth of one side of a DVD, one layer being of a standard DVD format and the other being of the HD DVD format, and a third dual or single BD data layer on the same side of the DVD at a different depth. Fourth, by providing discs that have a dual or single BD data layer on one side of a disc, and a dual or single HD or DVD layer on the other side of a disc. Fifth, by providing discs that have a dual or single BD data layer and either of a dual or single HD or DVD layer on one side of a disc, and a dual or single HD or DVD layer (whichever format was not used on the first side) on the other side of the disc. Sixth, by providing discs that utilize the SD DVD-9 physical format, but which have two different formats selected from the HD, 80 or DVD application formats on the separate physical layers. Seventh, by providing discs that have at least two of the HD, 80 or DVD formats on one side of the disc, as disclosed herein, and a CD format optically accessible from the same side of the disc. In this manner, various discs can be made by combining the physical (or mechanical), logic and application layers or components of various types of formats, such as HD, 80 or DVD formats.

### BRIEF DESCRIPTION OF THE FIGURES

FIGS. 1A-1F show partial cross sectional views of several known DVDs;

FIG. 2 shows a partial cross sectional view of a known HD-DVD;

FIG. 3 shows a partial cross-sectional view of a known BD-DVD;

FIG. 4 shows a partial cross-sectional view of a first embodiment of the present invention;

FIG. 5 shows a block diagram of a player for the disc of FIG. 4; and

FIGS. 6-24 show various other embodiments of the invention a second embodiment of the invention.

### DETAILED DESCRIPTION OF THE FIGURES

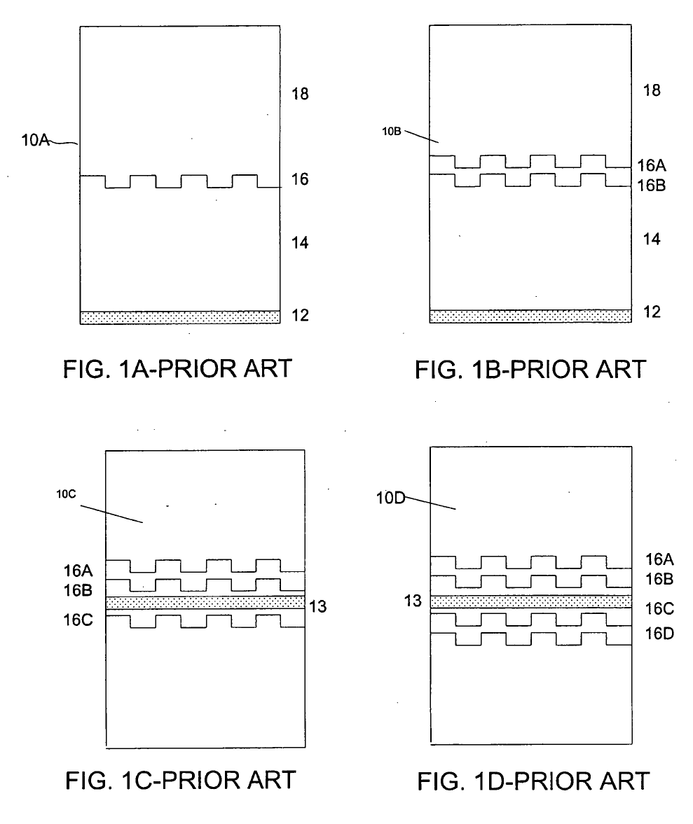

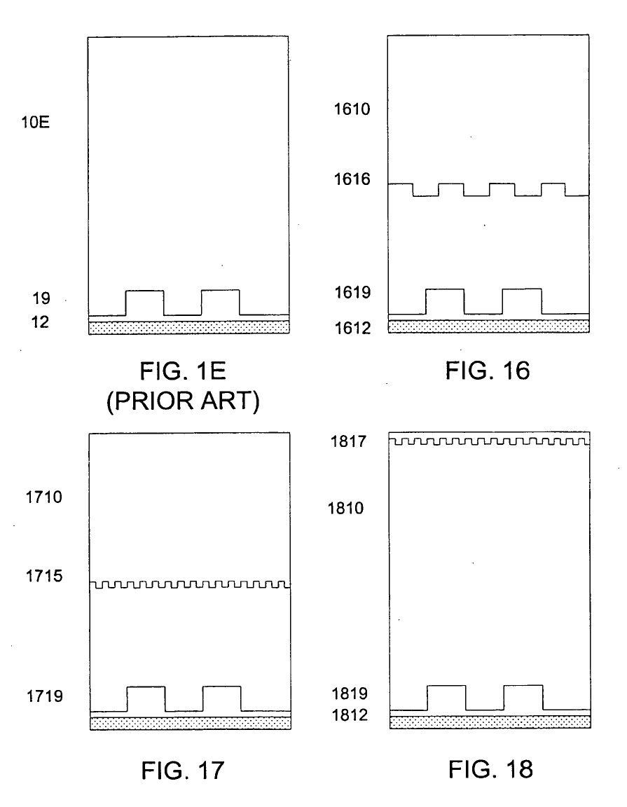

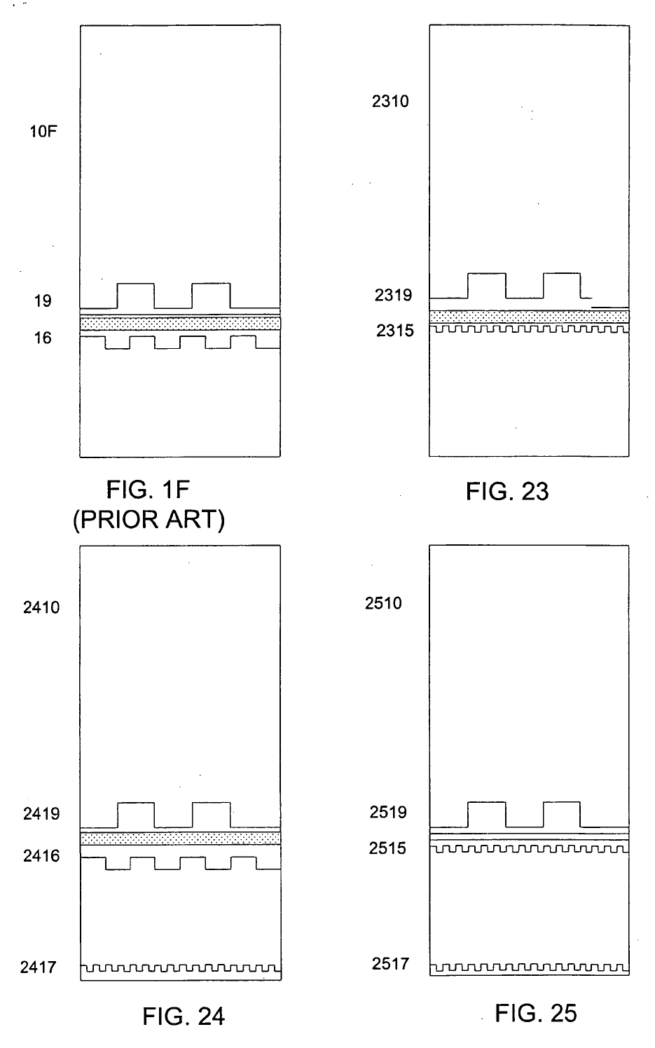

FIGS. 1A-F show several standard DVD formats.

FIG. 1A shows a standard DVD disc 10A having the characteristics listed above. Starting from the bottom, disc 10 includes an opaque label 12, a polycarbonate layer 14, a data layer 16 and another polycarbonate layer 18. The last layer 18 has a nominal thickness of 0.6 mm and may be covered with a protective coating (not shown). It should be understood that the discs in the drawings have been simplified for the sake of clarity and that various layers, including glue and resin layers well known to those skilled in the art have been omitted.

FIG. 1B shows a DVD 108 with two data layers 16A, 168. The two data layers are disposed very close together, and they are formed at a nominal depth of 0.6 mm.

FIG. 1C shows a double sided DVD 10C with a separator layer 13. One side has two data layers 16A, 16B and the other side has one data layer 16C.

Finally, DVD 100 in FIG. 1D has two sides, each side including two data layers, 16A, 16B and 16C, 160, respectively. DVDs 10A, 10B, 10C and 100 are generally referred to as a DVD-5, DVD-9, DVD-14 and DVD-18, the numerals being indicative of the nominal data capacity of the respective disc.

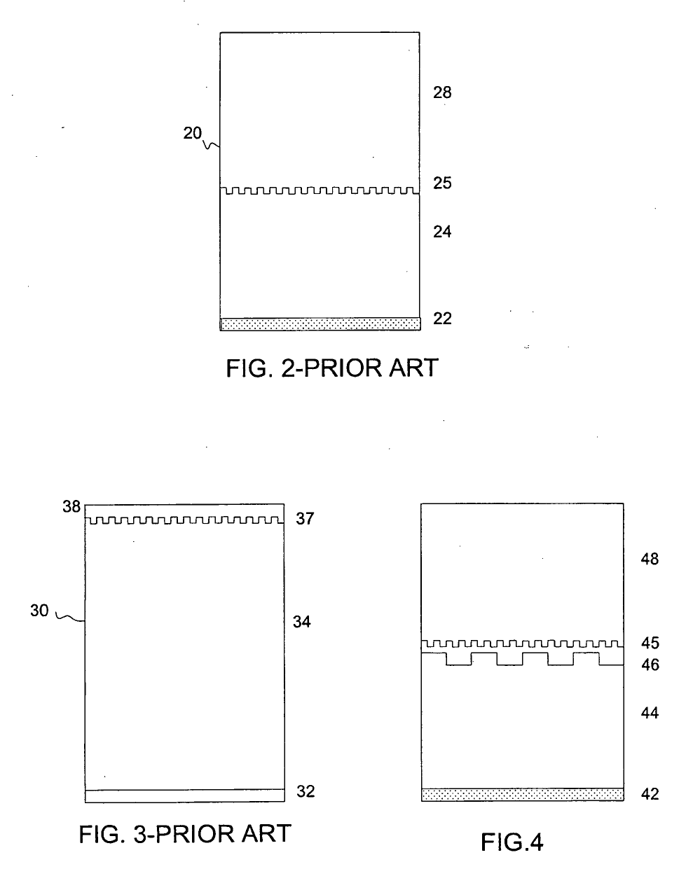

FIG. 2 shows a known HD-DVD disc 20 including a label 22, polycarbonate layer 24, data layer 25, and a second polycarbonate layer 28. Layer 28 has the same nominal thickness as layer 18.

FIG. 3 shows a known Blu-ray disc or BD 30 including a label 32, polycarbonate layer 34, data layer 36, and second polycarbonate layer 38. Layer 38 has a nominal thickness of 0.1 mm.

Data layers 25 and 36 from discs 20 and 30 have the characteristics described above. Because of the differences in the characteristics of these discs, neither an HD-DVD nor a BD disc can be read by a standard DVD player.

FIG. 4 shows a first dual disc 40 constructed in accordance with this invention. Disc 40 has two data layers: a data layer 46 having the same characteristics as layer 16, and a data layer 45 having the characteristics of data layer 25. Layer 48 has a nominal thickness of 0.6 mm.

The disc 40 can be used in various ways. For example, in one embodiment, the DVD layer 46 can be used for a standard movie while layer 45 can be used for the same movie and some enhancements and/or additional information. This additional information may include dialog in additional languages, or background information about the movie, the characters, the actors, the director, etc. Discs of this configuration could be read with either a standard DVD player, or an HD-DVD player, each player reading only one of the data layers.

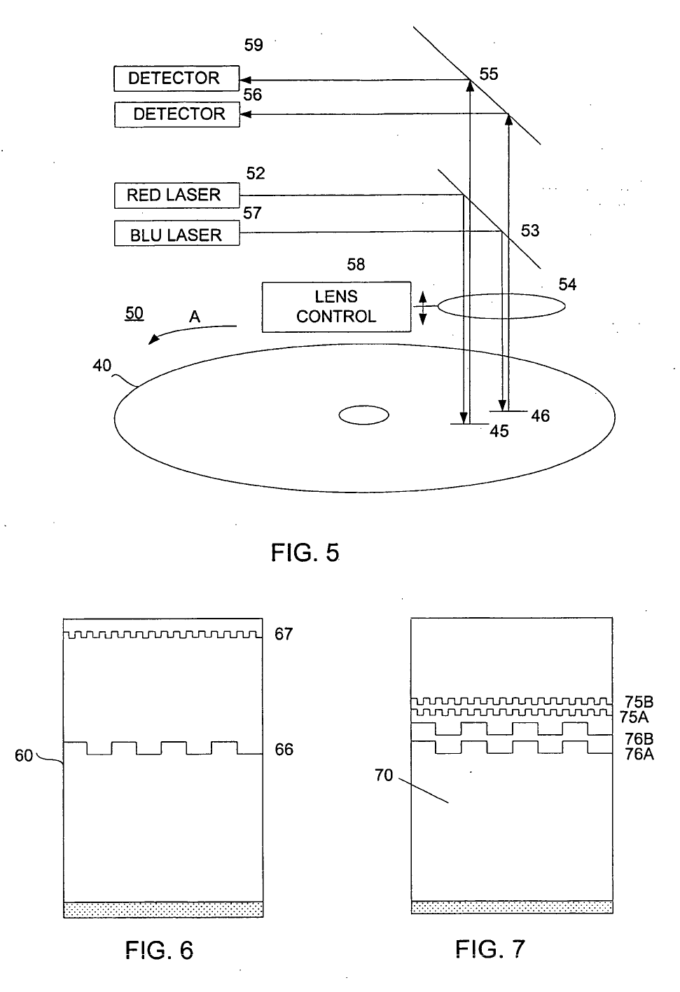

Alternatively, either layer may be used only for the movie, while the other layer may be used for other content. Discs of this configuration can be read using a special player. One such player 50 is shown in FIG. 5. In this player 50, the disc 40 is rotated about its axis in the direction indicated by arrow A. The player includes a red laser 52 generating a beam that is directed at the surface of the disc 40 by a head including a mirror 53 and a lens 54 The beam is reflected by the data layer 46, it passes through the lens 54, and mirror 53 and is reflected by mirror 55 to detector 56.

In one advantageous embodiment, the low capacity data layer (e.g. the DVD or CD data layer) is used merely to generate a message for a customer. For example, the message may provide text indicating that the disc has high capacity data layers requiring a corresponding player and that normal players (e.g. a standard DVD or a CD player) will not be able to play the remaining content of the disc. When this disc is inserted into a DVD or CD player, the player only finds this message and presents or otherwise renders the text to the customer and then stops.

A separate but similar head may be used to read data layer 45. Alternatively, a single head is used to read both data layers. In this configuration, a blue-indigo laser 57 generating a beam at 405 nm is directed at the disc 40 through the mirror 53 and lens 54. The beam is reflected by the data layer 45 passes through the lens 54 and mirrors 53, 55. If necessary, a lens controller 58 is used to change the position of the lens 54 and/or mirror 53 to insure that the laser beam from laser 57 is properly focused. This beam is then sensed by a second detector 59. In this manner, the player 40 can be used read both data layers 45, 46.

In an alternate embodiment, a single head with a blue laser 57 is used to read both data layers 45, 46, and the red laser 52 is omitted. Of course, if a blue laser is used to read the low density layer (46) then a different data detection scheme is required due to the different diffraction effects when the spot size is smaller than the pit size. Also if the pit depth is left at red laser value, the interference that leads to the playback data signal will not be optimized. There fore for best results this low density layer would have a pit depth similar to the high density layer (45), but a low areal density, as in 46.

A second dual disc 60 is shown in FIG. 6. This disc 60 has two data layers as well: a data layer 66 similar to data layer 16 and a data layer 67 similar to data layer 37. The substrate covering layer 67 has a nominal thickness of 0.1 mm.

The selection and use of reflective and semi-reflective materials on the various layers of optical discs read by lasers, including HD-DVD, Blu-ray, DVD and CD, is well known to those skilled in the art. As a general matter, as the number of data layers increases on one side of an optical disc, the amount of acceptable reflectivity of each layer decreases. By reducing the reflectivity of the layers the transmissivity can be increased. The increased transmissivity of the upper layers is required in order to minimize the attenuation of the read beam as it passes through those layers to be reflected from the lower information layers, thus maximizing the magnitude of the reflective readout signal detected from the lower layers. For example, in standard DVD, using a single layer, reflectivity can range from 5-100%, with 45-85% most preferred. With dual layers, reflectivity can range from 5-45% with 18-30% most preferred. With three layers, the range of reflectivity narrows further, with a possible range of 5-30% with 5-25% most preferred. The reflectivity standards for HD DVD and SD discs are similar. For HD DVD, the most preferred reflectivity range for single layer discs is 40-70%, and for dual layer 18-32%. For BD discs, the respective ranges are 35-70% and 12-28%. In addition, in the case of multiple layer optical discs, the difference in reflectivity between adjacent reflective data layers must be controlled in order to ensure sufficient reflectivity of the subsequent data layer such that said difference is less than or equal to 5% with about 3% being preferred. The selection of reflectivity for the various data layers is discussed in detail in U.S. Pat. Nos. 6,790,503, 6,673,410, 6,623,827 and 5,171,392, and references cited and discussed therein, U.S. Patent Publication No. 2003/0099806 and references cited and discussed therein, the publication “SPIE Conference Proceeding Vo. 2890, pages 2-9, November 1996,and ECMA International Standard ECMA-267 20 mm DVD Read-Only Disk, 3rd ed. (April 2001)” ( http://www.ecma ,international.org/publications/standards/Ecma-267.html) all incorporated herein by reference.

As mentioned above, standard DVDs are also available with multiple data layers disposed adjacent to each other. A similar dual disc can be made with multiple standard data layers as well as multiple high-capacity data layers. FIG. 7 shows such a disc 70 with two standard DVD data layers 76A, 76B and at least one high-capacity layer 75A. Optionally, a second high-capacity layer 75B is also provided. Data layers 75A, 75B have the same characteristics as layer 45.

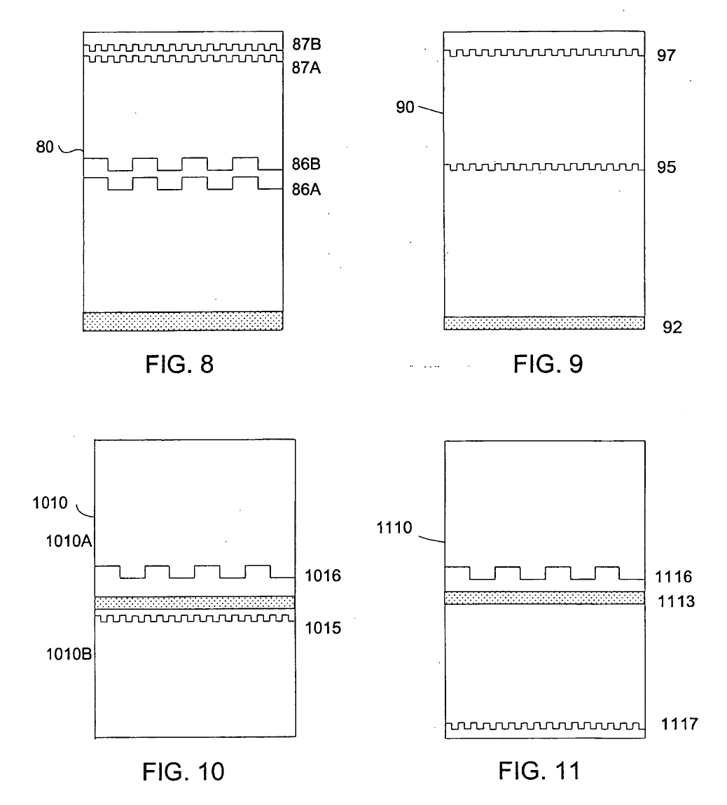

FIG. 8 shows a similar configuration with two standard DVD data layers 86A, 86B and two BD data layers 87A, 87B.

Finally, FIG. 9 shows yet another embodiment with one HD data layer 96 and one BD data layer. Of course, disc with two HD data layers and two BD data layers may be provided as well.

In all the embodiments described so far, a disc is provided that has an opaque label on one side and data from two or more data layers is read from the other side.

However, as discussed above, standard DVDs are also known that have two sides. The following embodiments disclose improved DVDs with two sides, at least one side having a high capacity (either HD or BD) data layer. This may be accomplished by reducing the nominal width of one of the sides.

One such disc 1010 is shown in FIG. 10. The disc 100 has two sides 1010A, 1010B. Side 1010A includes a standard DVD data layer 1016, while side 1010B has a high-capacity HD data layer 1015. While in the previous embodiments, the data layers are read from the same side of the respective disc, in the present embodiment, data layer 1015 is read from one side and data layer 1016 is read from the opposite side of the disc.

FIG. 11 shows a disc 1110 similar to disc 1010 with a standard DVD data layer 1116 on one side and a high-capacity BD data layer 1117 on the other side. Both discs 1010 and 1110 can be read by either a standard DVD player or a high capacity player by inserting the respective disc into the player with the proper side facing the laser head.

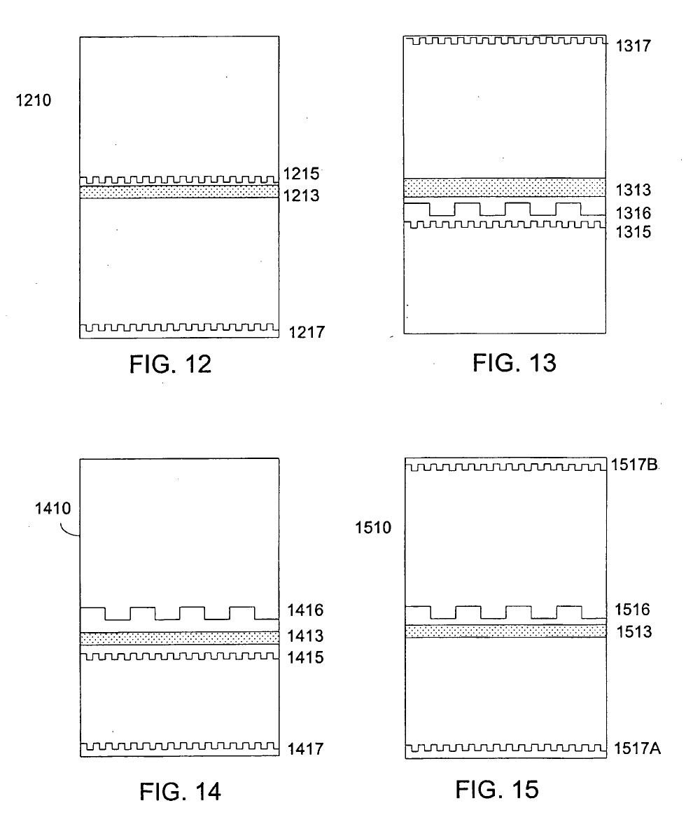

A dual disc may also be formed with two high-capacity data layers, one conforming to the HD-DVD format and the other conforming to the BD format. One such disc 1210 is shown in FIG. 12. Disc 1210 has one HD data layer 1215 and a BD data layer 1217 that is similar to 37.

A dual disc may also be formed using a SD physical format disc, corresponding to a DVD-9 disc, that uses a different application format selected from the HD-DVD, BD and SD DVD application formats on each layer. The physical format of such a disc is shown in FIG. 1B, which depicts the prior art “DVD-9” format disc. Using the DVD-9 physical format shown in FIG. 1B, such a dual disc has one application disc format, such as the BD format, on layer 16A, and a different application disc format, such as SD DVO, on layer 16B.

Two sided discs may also be provided that include various other configurations of data layers. FIG. 13 shows a disc with a BD data layer 1317 on one side and a DVO data layer 1316 with a BD data layer on the other. FIG. 14 shows a DVD layer 1416 and an HD DVD data layer 1415 with a BD 1417 on the other.

FIG. 15 shows a disc 1510 with a BD data layer 1517A on one side and a DVD data layer 1715 with a BD data layer 1517B on the other.

Similar discs can be formed with one data layer being a standard CO layer. A standard CD 10E is shown in FIG. 1E with a label 12 and a CD data layer 19. FIG. 16 shows a dual disc 1610 with a CD data layer 1619 and a DVD data layer 1616. FIG. 17 shows a dual disc 1710 with a BD data layer 1715, FIG. 18 shows a disc 1810 with a CD data layer 1819 and a BD layer 1817.

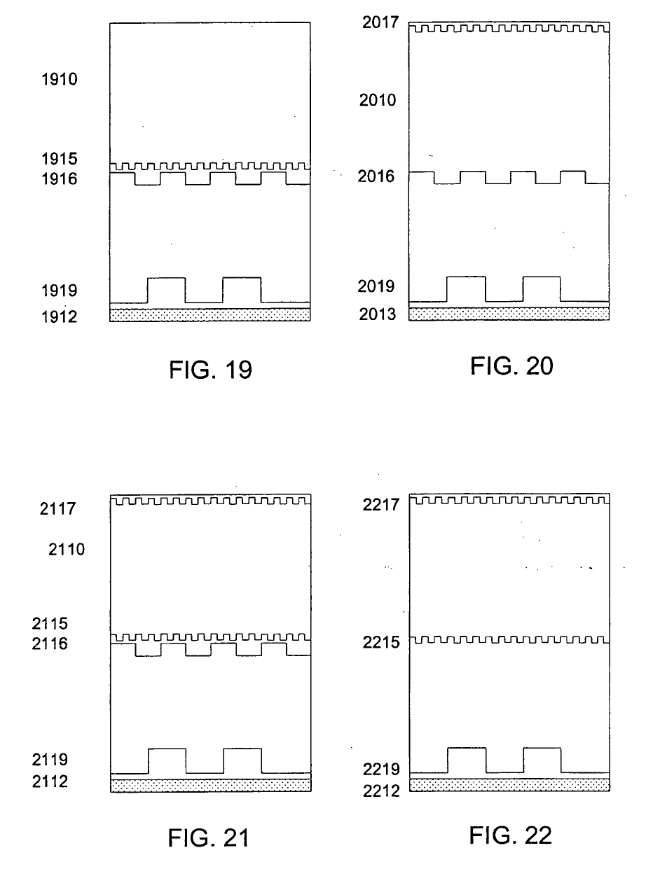

FIG. 19 shows a disc 1910 with a DVD data layer 1916 and an HD data layer 1915.

FIG. 20 shows a disc 2010 with a CD data layer 2019 and a BD data layer 2017.

FIG. 21 shows a disc 2110 with a CD data layer 2119, a DVD data layer 2116, an HD data layer 2115 and a BD data layer 2117.

FIG. 22 shows a disc 2210 similar to disc 2110 with the DVD data layer 2116 omitted.

The novel discs disclosed so far all have a thickness that is either equal to or just slightly larger than the thickness of a standard DVD or CD disc. Another known disc is shown in FIG. 1F. This disc 10F has a nominal thickness of 1.6 mm with one side including a CD data layer disposed at a nominal depth of 1.2 mm and a second side having a DVD data layer 16. Modifications to this disc are shown in FIGS. 23-25. In all these Figures one side has CO data layer. In FIG. 23 disc 2310 has a second side with an HD data layer 2315. In FIG. 24 disc 2410 has a second side with a DVD layer 2416 and a BD data layer 2417. In an alternate embodiment, the DVD data layer 2416 is omitted. In FIG. 25, disc 2510 has a second side with an HD data layer 2515 and a BD data layer 2517.

Numerous modifications may be made to the invention described herein before departing from its scope as defined in the appended claims.

We claim:

1. A multi-format optical disc comprising:
a substrate;
a first data layer disposed on said substrate, said first data layer conforming to a first protocol;
a second data layer supported on said substrate, said second data layer conforming to a second protocol; and
a transparent protective layer disposed on top of said first and second layers.

2. The optical discs of claim 1 wherein said first data layer conforms to a standard DVD protocol and said second data layer conforms to a high capacity protocol.

3. The disc of claim 1 wherein said two data layers conform to two different types of high capacity protocols.

4. The disc of claim 1 wherein the first data layer conforms to an HD-DVD protocol and said second data layer conforms to a BD protocol.

5. The disc of claim 1 wherein the two data layers overlap.

6. The disc of claim 1 wherein said first data layer includes data characterizing the second data layer.

7. The disc of claim 6 wherein said first data layer includes one of a text and an audio file describing said second protocol.

8. The disc of claim 1 further comprising a third data layer, wherein the three data layers conform to different protocols.

9. The disc of claim 1 further comprising a third layer, wherein one of said layers conforms to one protocol, and the two other layers conform to a second protocol.

10. A multi-format optical disc comprising:
a support layer including a substrate with a first and a second side;
a first data layer disposed on said first side and conforming to a first protocol; and
a second data layer disposed on said second said side and conforming to a second protocol;
wherein at least one of said first and second protocols is a high capacity protocol including one of an HD-DVD protocol and a BD protocol.

11. The optical disc of claim 10 wherein one of said data layers conforms to a standard DVD protocols.

12. The optical disc of claim 10 wherein one of said data layers conforms to a CD protocol.

13. The optical disc of claim 10 further comprising a third data layer disposed on said first side.

14. The optical disc of claim 13 wherein said third data layer conforms to one of a standard DVD protocol and a high capacity protocol.

15. The optical disc of claim 13 wherein said first and third data layers overlap.

16. The optical disc of claim 10 wherein said substrates conform to one of a physical, logical and application formats, said formats being selected from DVD, HD and BD formats.

17. The optical disc of claim 16 wherein one of said layers conforms to a first format and it least one of the remaining layers conform to a second format.

18. A player for playing an optical disc with multiple data layers including a first data layer conforming to a first protocol and a second data layer conforming to a second protocol, said player comprising:
a data detector detecting data on said optical disc, including data on said first data layer and said second data layer; and
a controller coupled to said data detector and being adapted to operate said player based on the presence of data from both data layers.

19. The player of claim 18 wherein said data controller is adapted to detect data following several protocols selected from the group consisting of DVD, HD and BD protocols.

20. The player of claim 17 wherein said first protocol is a low capacity protocol and said second protocol is a high capacity protocol selected from one of an HD-DVD and a BD protocol.

21. A multi-format optical disc comprising:
a substrate;
first and second data layers disposed on the same side of said substrate, said first and second data layers conforming to the physical format of a SD DVD-9 disc, wherein the first data layer has a application format selected from the group comprised of the BD, HD-DVD and SD formats and the second data layer has a different application format selected from the same group; and
a transparent protective layer disposed on top of said first and second layers.

22. A multi-format optical disc comprising:
a substrate;
first and second data layers disposed on the same side of said substrate, said first and second data layers conforming to the physical format of a SD DVD, wherein the first data layer has a application format selected from the group comprised of the BD, HD-DVD and SD formats and the second data layer has a different application format selected from the same group; and
a transparent protective layer disposed on top of said first and second layers.
